(19) United States
(12) Patent Application Publication
(10) Pub. No.: US 2024/0373985 A1
(43) Pub. Date: Nov. 14, 2024

(54) SOLE OF A SHOE AND INSOLE FOR INSERTION INTO A SHOE

(71) Applicants: Andreas SEXTL, Schoengeising (DE); Patrick MEISTER, Diessen a. A. (DE)

(72) Inventors: Andreas SEXTL, Schoengeising (DE); Patrick MEISTER, Diessen a. A. (DE)

(73) Assignees: Andreas SEXTL, Schoengeising (DE); Patrick MEISTER, Diessen a. A. (DE)

(21) Appl. No.: 18/688,025

(22) PCT Filed: Aug. 30, 2022
(86) PCT No.: PCT/EP2022/074060

§ 371 Date: Feb. 29, 2024

(30) Foreign Application Priority Data
Sep. 1, 2021 (DE) 20 2021 104 706.2

(51) Int. Cl. A43B 17/14; A43B 1/028; A43B 1/05; A43B 5/06; B29D 35/14; B29K 63/00; B29K 105/08; B29K 307/04; D03D 15/275

(52) U.S. Cl. CPC A43B 17/14; A43B 1/028; A43B 1/05; A43B 5/06; D03D 15/275; B29D 35/14; B29K 2063/00; B29K 2105/0845; B29K 2307/04; D10B 2501/043

(57) ABSTRACT

An insole for loose insertion into a shoe, wherein the insole has at least the following layer structure with a first layer made of carbon fiber-reinforced plastic, one or more intermediate layers and a second layer made of carbon fiber-reinforced plastic, the layers being arranged essentially one above the other at least partially.

### TECHNICAL FIELD

The invention relates to a shoe, a sole of a shoe, an insole for inserting into a shoe, a method for producing an insole and the use of an insole in a shoe.

### PRIOR ART

It is known from the prior art that depending on the intended use of a shoe, the overall configuration of the upper material and the sole structure can vary significantly. A sports shoe in particular is typically characterized by a compressible and flexible sole structure, which has a large number of additional functional elements such as moderators, liquid-filled chambers, damping components or elements for influencing movement. These functional elements in particular fulfill orthopedic purposes and/or can increase the athlete's running performance. The skilled person understands the term “running performance” as the level of goal achievement that the runner/athlete achieves at the maximum use of his/her performance, i.e. the optimum of his/her performance capability.

For example, U.S. Pat. No. 5,052,130 B discloses a running shoe in which a leaf spring-like elastic element made of fiber-reinforced polymer material is firmly integrated between the outsole and midsole. Due to the predetermined fixed arrangement in the shoe sole structure and a corresponding bending characteristic, the elastic element bends together with the shoe sole in the area of the ball of the athlete's foot and interacts with the natural spring action of the foot biomechanism with every step. In this way, the runner's natural foot movement is supported by storing and releasing energy and the running process is optimized.

However, the production of the footwear described above causes significantly higher costs than the production of shoes without a functional element. In addition, there is a need to optimize sports shoes with regard to their effect on the athlete's running performance using simple and cost-effective means.

### SUMMARY OF THE INVENTION

The invention is based on the object of being able to design a shoe, in particular a sports shoe, in a variable and/or improved manner, in particular to optimize it, with regard to its effect on the athlete's running performance.

According to the invention, this object is achieved by an insole having the features of claim 1. Advantageous embodiments of the invention can be found in the dependent claims.

The invention is based in particular on the knowledge that a functional element which has a positive influence on running performance may be retrofitted into a shoe. At the same time, it has been recognized that a as far as possible flat or thin functional element helps ensure that the fit and the existing sole structure consisting of the outer, middle and insole of the shoe are not significantly adversely changed by the inserted functional element. In addition, the material and the layer structure of the functional element should preferably be designed in such a way that a maximum spring effect is supported while at the same time being highly resistant to breakage and the shape of the functional element can be adapted to different shoe sizes.

Using these findings, the invention according to claim 1 provides an insole for loose insertion into a shoe, preferably in addition to a loose, more preferably under a loose insole of the shoe. The insole has at least a first layer made of carbon fiber-reinforced plastic, one or more intermediate layers and a second layer made of carbon fiber-reinforced plastic, the layers being arranged essentially one above the other, at least in sections.

In this context, the term insole refers to the sole in a shoe that is in direct contact with the foot or the wearer's footbed. Loosely inserting an insole or a loose insole means that the corresponding sole can be removed from the shoe and reinserted in such a way that no firmly connected structures between the sole and the shoe are changed and/or destroyed in a substantially irreversible manner. However, it is also conceivable that there is something between the shoe and the loose insert or that the insole has a reversibly detachable connection, for example a Velcro fastener, a magnetic connection or snap fasteners.

The first and second layers can in particular be configured as an upper or lower cover layer. In other words, the first and second layers in particular each represent the outermost layer of the layer structure of the insole.

However, it is also particularly conceivable that further layers lie outside the first and second layers. However, these additional layers do not have any structural properties that have a direct impact on the athlete's running performance.

The invention thus makes it possible, for example, for a shoe to be variably optimized in terms of its effect on the athlete's running performance with the help of the additionally insertable insole. In other words, the insole can also be inserted into the shoe, but can also be removed again. The sole according to the invention bends together with the shoe sole in the area of the ball of the athlete's foot and interacts with the natural spring action of the foot biomechanism with every step. This allows the runner's natural foot movement to be stored and released supported by deformation energy and increased running performance.

The described layer structure made of carbon fiber-reinforced plastic also supports such a thin layer thickness of the insole to the effect that the fit of the shoe is not changed to the detriment of the wearer when an additional insole is inserted.

The present invention is not limited to sports shoes, but includes all footwear or types of shoes.

Another advantage is that carbon fiber-reinforced plastic has a low mass and high rigidity at the same time. This means that the inserted insole only slightly increases the overall weight of the shoe. At the same time, the risk of breakage of the insole is minimal.

In addition, it is advantageous that by inserting the insole under an already existing insole, the athlete's foot is still only in direct contact with the footbed of the existing insole of the shoe. This is particularly advantageous if the insole is an orthopedic insole, whereby its properties can continue to have a beneficial effect on the user.

However, this does not exclude the possibility that the insole can be inserted instead of the already existing insole. In other words, the insole can replace the existing insole.

The insole is preferably designed in such a way that the one or each of the multiple intermediate layers have a carbon fiber laid fabric, the carbon fibers of which are preferably aligned essentially unidirectionally. A unidirectional alignment can in particular be a unidirectional alignment in running or longitudinal direction, or in other words, an orientation from the heel to the toes of a foot. This is advantageous in that the one or each of the multiple intermediate layers of the insole provide high strength and rigidity. A higher strength and stiffness ultimately have a positive effect on the bending characteristics of the insole in such a way that a correspondingly larger amount of deformation energy is stored and released again by the insole. In this way, the running process can be maximally supported and running performance can be optimally increased. Furthermore, high material strength protects the insole from breakage.

It is also preferred for the insole that the first and second layers each have a carbon fiber woven fabric, the carbon fibers of which are preferably woven in a twill weave. This enables the insole to remain resistant to transverse forces that occur. Transverse forces are the forces that occur transversely to the running direction, or in other words, from the inner instep to the outer instep of the foot.

In an even further preferred embodiment, the insole is designed such that the carbon fibers of the carbon fiber laid fabric of the first and second layers are essentially aligned at a 0°/90° angle relative to the carbon fibers of the carbon fiber woven fabric of the one or more intermediate layers. Such an alignment supports maximum rigidity, meaning that both longitudinal and transverse forces can be absorbed in the best possible way. However, it is also conceivable that the carbon fibers of the carbon fiber laid fabric of the first and second layers are aligned at an angle other than a 0°/90° relative to the carbon fibers of the carbon fiber woven fabric of the one or more intermediate layers, for example at a 0°/45° angle. In this way, the stiffness can be reduced if necessary.

Furthermore, the insole is preferably designed in such a way that the first and second layers and the one or more intermediate layers extend continuously over the entire course of the insole. In this way, the corresponding structural properties are better throughout. The insole is distributed over the course of the insole and can have an effect in every area. In this way, the insole can optimally absorb and release the corresponding forces.

Further preferably, the insole is designed such that the first and second layers each form a, preferably continuous, essentially planar surface. This makes it possible to easily insert the insole under an existing insole. At the same time, the forces acting on the shoe are better distributed evenly over the existing sole onto the planar surface of the inserted insole. In this way, the insole can optimally absorb and release the corresponding forces. In addition, the existing insole is loaded more homogeneously, which improves walking comfort.

It is also preferred that the insole has a constant layer thickness. This offers the advantage that there is a continuously constant layer thickness across the entire insole. This means that the forces acting on the shoe can be evenly distributed over the existing soles to the inserted insole. In this way, the insole can optimally absorb and release the corresponding forces.

Furthermore, it is preferred that the insole has a layer thickness of at most 1.2 mm, preferably at most 1.0 mm, and/or the first and second layers each have a layer thickness of at most 0.3 mm, preferably at most 0.25 mm, and/or the one or more intermediate layers have a total layer thickness of at most 0.6 mm, at most 0.5 mm. This configuration creates an insole that has an optimal ratio between maximum strength and stiffness and minimal layer thickness and optimally improves running performance.

It is also preferred that an area of the insole, in particular an area that is not loaded by a heel, has a (in particular single) arching, the arching in particular having a vertex with two legs, with a rear leg connecting to an area that is loaded by the heel, and a front leg connecting to the area that is not loaded by the heel, or is part of it. Preferably, the front leg lies at least in sections in the area of the ball of the foot. More preferably, several vertices extend continuously from an inner instep to an outer instep of the insole or line up next to each other, viewed in the left-right direction. A vertex is the point in a plane that runs from front to back in relation to the foot, i.e. in the direction of running, in which the curvature/slope changes. A series of vertices in different levels (in the left-right direction) can form a vertex progression in this direction (i.e. from right to left). In other words, in order to further support the natural spring effect of the foot biomechanism, for example, a front area of the insole in the running direction, in particular an area that is not loaded by the heel, or an area that extends from the arching of the foot to the toe area in the direction of running must be curved throughout. The front area can be at least half of the sole, which preferably corresponds to the forefoot.

In other words, said front area is designed as a single continuous curvature, so that a vertex is formed between the heel area and the toe area in a sectional view in the longitudinal direction (this corresponds to the direction of the longitudinal extent of the insole), which is on an upper side of the insole (side which is loaded by the foot). A corresponding rear leg of the apex begins, for example, at or in front of the heel area of the apex of the insole and a front leg begins, for example, at the toe area of the insole or is part of the toe area of the insole. The apex course runs essentially transversely from the outside of the insole (as an imaginary line), preferably essentially perpendicular to the running direction or from the inner instep to the outer instep of the insole. It is clear to the person skilled in the art that all vertices of the vertex course are followed by the front and rear legs described above.

Furthermore, it is preferred that in an area of the insole, in particular an area that is loaded by a heel, there is a bead, which is in particular essentially elongated and/or runs lengthwise in the running direction of the insole. In other words, it has proven to be advantageous if the insole has a bead or a deepening is incorporated. The bead, for example elongated, runs essentially lengthwise in the running direction of the insole, particularly in the heel area, with the depression in the bead being formed, for example, downwards in the direction of the contact surface of the insole in the shoe. This has the effect that the rear part of the insole in the running direction, in particular the heel area of the insole, has an even higher stiffness and thus the stability of the rear foot and ultimately the spring effect is increased.

Furthermore, the insole is preferably designed in such a way that an outermost layer of the layer structure and/or the insole is a tear-off fabric. This ensures that the foot is suspended on the insole and thus increases walking comfort. At the same time, the rough surface of the tear-off fabric ensures a better grip for the foot on the insole compared to a ground carbon surface and/or ensures a better grip of the insole in the shoe.

In addition, it is preferred for the insole to be foamed, at least partially and in particular completely, with a foam material. This has the advantage that the foot is suspended on the insole and thus increases walking comfort. At the same time, a coefficient of friction can be set by choosing a suitable foam material, so that a better grip for the foot on the insole is guaranteed.

A shoe with the insole described above is also considered. The technical effects and advantages described above can also be transferred to the shoe with the insole.

Also considered is the use of an insole for a shoe to increase running performance, with the insole being inserted loosely into the shoe, preferably in addition to a loose, more preferably under a loose insole of the shoe. In this way, a shoe can be variably optimized in terms of its effect on the athlete's running performance with the help of the additional insertable insole. In other words, the insole can also be inserted into the shoe, but can also be removed again.

In addition, a method according to the invention for producing an insole, in particular with the insole according to the invention, for loose insertion into a shoe is conceivable, which comprises the following steps:
Providing a carbon fiber laid fabric pre-impregnated with plastic, preferably epoxy resin, the carbon fibers of which are preferably aligned essentially unidirectionally;
Providing a carbon fiber woven fabric pre-impregnated with plastic, preferably epoxy resin, the carbon fibers of which are preferably woven in a twill weave;
Stacking the pre-impregnated carbon fiber laid fabric and the pre-impregnated carbon fiber woven fabric to form a layer structure such that the carbon fibers of the carbon fiber laid fabric form a first and a second layer, and the carbon fibers of the carbon fiber woven fabric form one or more intermediate layers between the first and second layer are arranged, the carbon fibers of the carbon fiber laid fabric is oriented substantially at a 0°/90° angle relative to the carbon fibers of the carbon fiber woven fabric forming the first and second layers;
Forming the layer structure by thermal hardening into a planar plastic-reinforced carbon fiber plate with preferably a constant layer thickness;
Cutting out the insole from the plastic-reinforced carbon fiber plate.

This manufacturing process offers, among other things, the advantage of initially producing a cost-effective plate blank, from which suitable insoles can then be individually cut in an independent process step. The cutting process can in particular be a water jet cut. However, other mechanical cutting methods using cutting tools are also possible. It is also advantageous that there is no need for complex subsequent processing of the cut edges.

However, the edges can be additionally smoothed flush by simply sanding them.

In addition to the above-mentioned aspects, features and properties of the insole and thereby or freely combinable with one another, the following points are also part of the present invention and disclosure. The features of the insole according to the invention correspond to possible features of the sole described below.
1. A (firmly) integrated sole in a shoe, the sole having at least the following layers: a first layer made of carbon fiber-reinforced plastic, one or more intermediate layers and a second layer made of carbon fiber-reinforced plastic, the layers being arranged essentially one above the other at least in sections.
2. Sole according to aspect 1, characterized in that the one or each of the multiple intermediate layers is a carbon fiber laid fabric, the carbon fibers of which are preferably essentially unidirectionally aligned.
3. Sole according to one of the previous aspects, characterized in that the first and second layers each have a carbon fiber woven fabric, the carbon fibers of which are preferably woven in a twill weave.
4. Sole according to aspects 2 and 3, characterized in that the carbon fibers of the carbon fiber laid fabric of the first and second layers are essentially aligned at a 0°/90° angle relative to the carbon fibers of the carbon fiber woven fabric of the one or more intermediate layers.
5. Sole according to one of the previous aspects, characterized in that the first and second layers and the one or more intermediate layers extend continuously over the entire course of the insole.
6. Sole according to one of the previous aspects, characterized in that the first and second layers each form a, preferably continuous, essentially planar surface.
7. Sole according to one of the previous aspects, characterized in that the insole has a constant layer thickness.
8. Sole according to one of the previous aspects, characterized in that the insole has a layer thickness of at most 1.2 mm, preferably at most 1.0 mm, and/or the first and second layers each have a layer thickness of at most 0.3 mm, preferably at most 0.25 mm, and/or the one or more intermediate layers have a total layer thickness of at most 0.6 mm, at most 0.5 mm.
9. Sole according to one of the previous aspects, characterized in that an area of the sole, in particular an area that is not loaded by a heel has a (single) arching, the arching in particular having a vertex with two legs, in particular a rear leg adjoins an area that is stressed by the heel, and in particular a front leg connects to the area that is not loaded by the heel, or is part of it.
10. Sole according to one of the previous aspects, characterized in that in an area of the sole, in particular an area that is loaded by a heel, there is a bead which is in particular essentially elongated and/or runs lengthwise in a running direction of the sole.
11. Sole according to one of the previous aspects, characterized in that an outermost layer of the layer structure and/or the sole is a tear-off fabric.
12. Sole according to one of the previous aspects, characterized in that it is foamed, in particular completely, with a foam material.
13. Shoe with a sole according to one of the preceding aspects, the sole being incorporated in particular into the shoe.
14. Use of a sole in a shoe, in particular according to one of the previous aspects, to increase running performance, wherein the sole is inserted into the shoe or, preferably in addition to a (loose), more preferably under a (loose) insole of the shoe.

### BRIEF DESCRIPTION OF THE DRAWINGS

Further features and advantages of the devices result from the following description of embodiments below by reference to the accompanying drawings. The drawings show in:

FIG. 1 a schematic top view of an intermediate layer of the insole according to the invention according to a first embodiment;

FIG. 2 a schematic top view of a first or second layer of the insole according to the invention according to a first embodiment;

FIG. 3 a schematic structure of the insole in a sectional view;

FIG. 4 a schematic structure of the insole according to a second embodiment in a sectional view;

FIG. 5 a schematic top view of the insole according to the second embodiment.

### DESCRIPTION OF EMBODIMENTS

It is obvious to the person skilled in the art that individual features, each described in different embodiments, can also be implemented in a single embodiment, provided they are not structurally incompatible. Likewise, various features that are described in the context of a single embodiment can also be provided in several embodiments individually or in any suitable sub-combination.

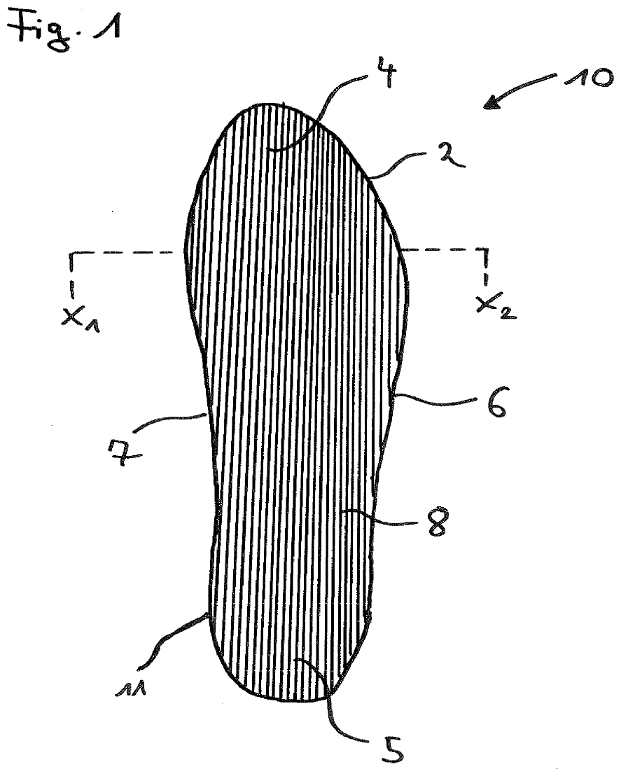

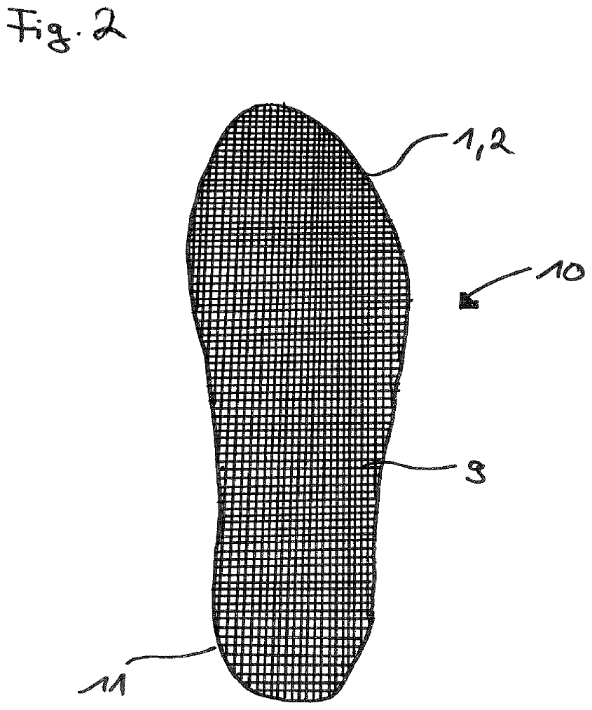

FIG. 1 shows a schematic top view of an intermediate layer 2 of the insole 10 according to a first embodiment. The intermediate layer 2 extends completely to the outer edge 11 of the intermediate layer 2. The outer edge 11 extends in particular in such a way that the shape essentially resembles the impression of a human right foot. The same outer edge 11 in particular also limits the first 1 and second 3 layers (FIG. 2). The shape of the intermediate layer 2 in FIG. 1 therefore also corresponds to the shape of the insole 10 in a top view; the intermediate layer 2 and the first 1 and second 3 layers are therefore congruent. Furthermore, the first 1 or the second 3 layer and the intermediate layer 2 have a rear heel area 5, a front toe area 4, an inner instep 7 and an outer instep 6. It is also clear to the person skilled in the art that the shape of the layers or the insole 10 can also essentially resemble the impression of a human left foot. However, it is also conceivable that the characteristic left or right shape of a footprint can be deviated from in such a way that the insole 10 is suitable for insertion into both a right and a left shoe. At this point it is clear to the person skilled in the art that the process step of cutting out the insole from the plastic-reinforced carbon fiber plate is carried out according to the method for producing an insole in such a way that the shapes described above are correspondingly realized for the insole.

In FIG. 1, the unidirectional course of the carbon fibers of the carbon fiber laid fabric 8 of the intermediate layer 2 is also shown schematically. All fibers here essentially run from the heel area 5 towards the toe area 4. In contrast, the first 1 and second 3 layers have a carbon fiber woven fabric 9 (FIG. 2), which is woven in a twill weave. The corresponding carbon fibers are unidirectional here from the heel area towards the toe area 5 or arranged perpendicularly from the inner instep 7 to the outer instep 6 and form a kind of network structure.

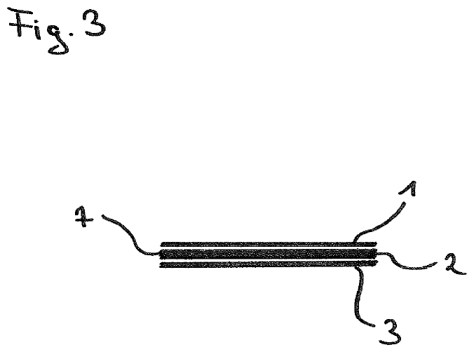

FIG. 3 shows a schematic sectional view (from X₁ to X₂) of the insole 10 from FIG. 1. The first layer 1 is located above and the second layer 3 is located below the intermediate layer 2. The intermediate layer 2 is therefore sandwiched between the first 1 and second 3 layers. The layers are essentially stacked horizontally on top of one another and have the same layer thickness throughout. All layers 1, 2, 3 extend vertically up to outer edge 7 and finish flush there. This layer structure is also implemented in the same way in the remaining areas of the insole 10. The surface of the first 1 and second 3 layers is designed to be planar, in particular over the entire course of the insole 10.

The carbon fibers of the carbon fiber woven fabric 9 and the carbon fiber laid fabric 8 are embedded in the corresponding layers in a plastic matrix, which can be, for example, an epoxy resin. The carbon fibers of the carbon fiber woven fabric 9 are preferably HS fibers (high strain) and the carbon fibers of the carbon fiber laid fabric 8 are preferably HM fibers (high modulus).

The insole described above can be used, for example, as follows. The insole is first inserted under the existing loose insole of a shoe. During running, the inserted insole bends with every step with the shoe in the area of the ball of the athlete's foot due to its defined bending characteristics and arrangement in the shoe. The inserted insole adapts to the natural movement of the foot and works together with the natural spring action of the foot biomechanism. The layers of carbon fiber-reinforced plastic store and release energy in response to this bending with each step, increasing running performance.

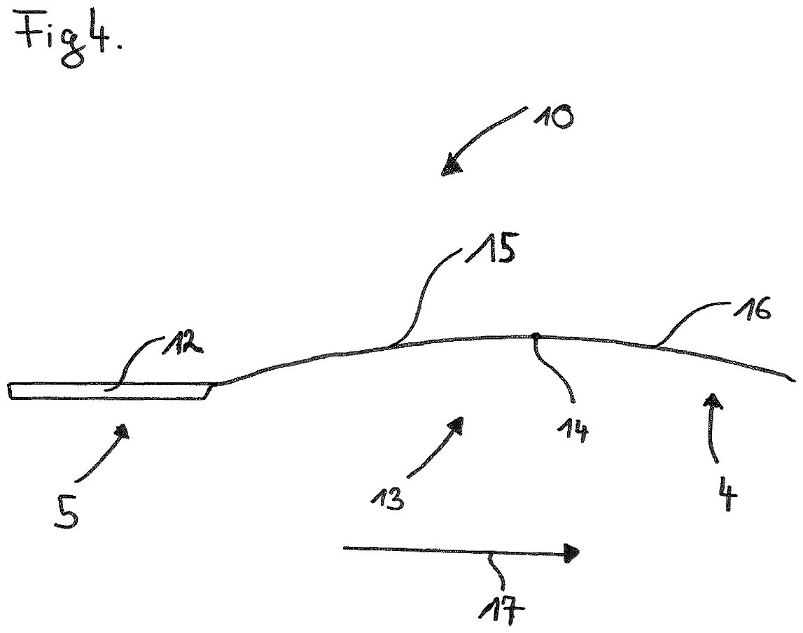

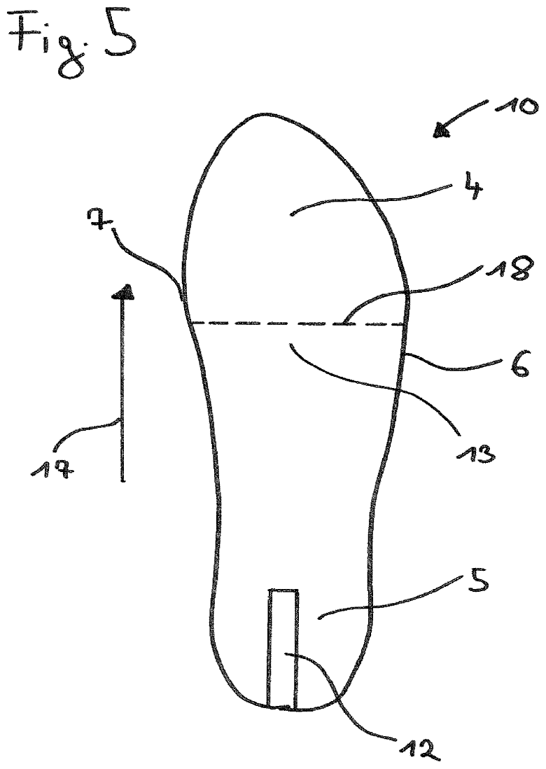

While in the first embodiment of the insole 10 the top and bottom have a continuously planar surface, the insole of the second embodiment has the features described below. The cross section of FIG. 3 also results from the second embodiment. FIG. 4 shows an insole according to the second embodiment in a sectional view and FIG. 5 shows it in a top view. In contrast to the embodiment of the insole 10 described in FIGS. 1 and 2, the insole 10 shown in FIGS. 4 and 5 has a arching 13 that adjoins the heel area 5 and extends to the edge of the toe area 4. The toe area 4 is part of the arching 13.

The arching 13 has a vertex 14, which is located on the top of the insole (side that is loaded by the foot). The apex course 18 of lined up apexes of the arching 13 runs in particular on an imaginary line from the inner instep 7 to the outer instep 6 of the insole 10, as indicated schematically in FIG. 5. The rear leg 15 of the arching, which is located to the left of the apex 14 in the sectional view of FIG. 4, adjoins the edge of the heel area 5. The other front leg 16 of the apex 14 is part of the toe area 4 and ends at the edge of the insole 10 in the toe area 4. The arching 13 of the insole 10 is curved upwards in the sectional view towards the sole of the runner's foot. The edge of the arching 13 can lie on a circle, for example. The circle radius can be 100 cm, for example.

If the weight of the foot acts on the insole, the arching 13 is bent and a counterforce of, for example, 50 N counteracts the weight of the foot. In this way, even more deformation energy is stored and released during the runner's natural foot movement, further increasing running performance.

In addition, FIG. 4 and FIG. 5 show a deep bead 12, elongated in the running direction, for example 7.5 cm (preferably between 4 to 10 cm, more preferably between 6 to 9 cm) long and approx. 1 cm (preferably between 0.5 and 2.0 cm) thick, incorporated into the heel area 5, the recess of the bead being embossed downwards towards the contact surface of the insole in the shoe.

The bead can also be in other forms known to the skilled person in order to further stabilize the heel area 5 in both the longitudinal and/or transverse direction. Due to the higher stiffness of the heel area 5 of the insole and the associated higher stability of the rear foot area, the spring effect is increased even further. It goes without saying that the arching 13 and the bead 12 cannot be present together, but can also be present independently of one another in the insole. E.g. the arching 13 and/or the bead 12 can be combined with the first embodiment.

The transition from the heel area to the arching 13 can be abrupt as the slope and even curvature changes.

It is also advantageous for all embodiments according to the invention if the outermost layer of the insole is a tear-off fabric, which forms a rough surface.

In this way, there is no need for complex grinding and greater sure-footedness is guaranteed.

The insole 10 according to the first and/or second embodiment can optionally be foamed with a foam material according to a third embodiment. In this way, for example, walking comfort can be increased. This also offers the advantage of replacing part of the insole 10 (made of carbon fiber) with foam material without changing the overall size of the (foam-covered) insole. The shape of the insole 10 (made of carbon fiber), which is located within the foam material, can even be reduced to such an extent that it only forms a substantially elongated strip shape extending from the heel area 5 to the toe area. It is clear to the person skilled in the art that such a reduction should advantageously only take place as long as there is still the advantageous effect that the reduced insole made of carbon fiber within the foam material supports the runner's natural foot movement by storing and releasing deformation energy and the running performance increased. The foamed insole could then be used not only in addition to an insole, but also instead of another insole in a (sports) shoe.

The invention was described above in accordance with various embodiments, all of which can be combined with one another, even in parts, with regard to an additional insole based on the drawings. However, as indicated, the invention can also be implemented in an insole that replaces or makes another insole unnecessary. It can have a footbed. The invention can also be used in a sole that is firmly integrated in a shoe, for example, as a shoe sole or outsole.

### LIST OF REFERENCE SIGNS

1 first layer
2 intermediate layer
3 second layer
4 toe area
5 heel area
6 outer instep
8 unidirectional fiber course; carbon fiber laid fabric
9 carbon fiber woven fabric
10 insole
11 outer edge
12 beading
13 bulge
14 vertex
15 posterior leg
16 front leg
17 running direction
18 vertex gradient

1-15. (canceled)

16. An insole for insertion into a shoe, the insole comprising:
a first layer made of carbon fiber-reinforced plastic;
one or more intermediate layers; and
a second layer made of carbon fiber-reinforced plastic, wherein
the layers are arranged at least partially one above the other.

17. The insole according to claim 16, wherein the one or each of the one or more intermediate layers has a carbon fiber laid fabric.

18. The insole according to claim 17, wherein the carbon fibers of the carbon fiber laid fabric are aligned essentially unidirectionally.

19. The insole according to claim 16, wherein the first and second layers each have a carbon fiber woven fabric.

20. The insole according to claim 19, wherein the carbon fibers of carbon fiber woven fabric are woven in a twill weave.

21. The insole according to claim 17, wherein the carbon fibers of the carbon laid fiber fabric of the first and second layers are essentially aligned at a 0°/90° angle relative to the carbon fibers of a carbon fiber woven fabric of one or more intermediate layers.

22. The insole according to claim 16, wherein the first and second layers and the one or more intermediate layers extend continuously over the entire course of the insole.

23. The insole according to claim 16, wherein the first and second layers each forms an essentially planar surface.

24. The insole according to claim 16, wherein the insole has a constant layer thickness.

25. The insole according to claim 16, wherein the insole has a layer thickness of at most 1.2 mm and/or the first and second layers each have a layer thickness of at most 0.3 mm and/or the one or more intermediate layers have a total layer thickness of at most 0.6 mm.

26. The insole according to claim 16, wherein an area of the insole has an arching.

27. The insole according to claim 26, wherein the arching has a vertex with two legs.

28. The insole according to claim 27, wherein a rear leg adjoins an area that is loaded by a heel, and a front leg adjoins or is part of the area that is not loaded by the heel.

29. The insole according to claim 16, wherein in an area of the insole there is a bead.

30. The insole according to claim 29, wherein the bead is essentially elongated and/or runs along its length in a running direction of the insole.

31. The insole according to claim 16, wherein an outermost layer of a layer structure and/or the insole is a tear-off fabric.

32. The insole according to claim 16, wherein the insole is foamed with a foam material.

33. A shoe, comprising:
an insole for insertion into a shoe, the insole having:
a first layer made of carbon fiber-reinforced plastic;
one or more intermediate layers; and
a second layer made of carbon fiber-reinforced plastic,
wherein the layers are arranged at least partially one above the other.
